(19) United States
(12) Patent Application Publication
(10) Pub. No.: US 2013/0203374 A1
(43) Pub. Date: Aug. 8, 2013

(54) APPARATUS AND METHOD FOR EFFECTING EMERGENCY SERVICE CALLS WITH A WIRELESS NETWORK

(71) Applicant: WEST CORPORATION, Omaha, NE (US)

(72) Inventors: John Lawrence Snapp, Westminster, CO (US); George Heinrichs, Longmont, CO (US)

(73) Assignee: WEST CORPORATION, Omaha, NE (US)

(21) Appl. No.: 13/647,858

(22) Filed: Oct. 9, 2012

Related U.S. Application Data
(60) Provisional application No. 61/594,432, filed on Feb. 3, 2012.

(51) Int. Cl. H04W 4/02

(52) U.S. Cl. 455/404.2

(57) ABSTRACT

A wireless telephone apparatus configured for operation with a wireless network; the apparatus comprising: an alerting actuator integrally coupled with the apparatus; actuating the alerting actuator effecting initiation of an emergency service call by the apparatus via the wireless network; and the apparatus and the wireless network cooperating to provide the emergency service call and location information regarding locus of the apparatus to an emergency service answering entity.

### FIELD OF THE INVENTION

The present invention is directed to telecommunication systems, and especially to effecting special number calls using a simplified actuator.

### BACKGROUND OF THE INVENTION

Because of inherent characteristics of the functionality and displays of user input controls on wireless devices or electronics containing wireless functionality, users may experience difficulty or confusion in attempting to place calls using such wireless devices. Such difficulty or confusion may be exacerbated in times of stress, such as when placing an emergency service call. Such difficulty or confusion may be even further exacerbated when a user of a wireless device is a child or an elderly person.

There is a need for a simplified apparatus and method for effecting emergency service calls with a wireless network.

### SUMMARY OF THE INVENTION

A wireless telephone apparatus configured for operation with a wireless network; the apparatus comprising: an alerting actuator integrally coupled with the apparatus; actuating the alerting actuator effecting initiation of an emergency service call by the apparatus via the wireless network; and the apparatus and the wireless network cooperating to provide the emergency service call and location information regarding locus of the apparatus to an emergency service answering entity.

A method for operating a wireless telephone with a wireless network; the apparatus comprising: (a) providing an alerting actuator integrally coupled with the wireless telephone; (b) actuating the alerting actuator to effect initiation of an emergency service call by the wireless telephone via the wireless network; and(c) operating the wireless telephone and the wireless network cooperatively to provide the emergency service call and location information regarding locus of the apparatus to an emergency service answering entity.

It is, therefore a feature of the present invention to provide a simplified apparatus and method for effecting emergency service calls with a wireless network.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram illustrating a system for effecting emergency service calls with a wireless network.

FIG. 2 is a schematic diagram illustrating call routing for a system configured according to the teaching of the present invention deployed in a representative multi-network arrangement

FIG. 3 is a call flow diagram illustrating details relating to effecting an emergency service call employing the teachings of the present invention.

FIG. 4 is a flow diagram illustrating the method of the present invention.

FIG. 5 is a schematic diagram of a display at an answering position indicating information provided by the present invention.

### DETAILED DESCRIPTION

For purposes of illustration, by way of example and not by way of limitation, the present invention will be discussed in the context of an emergency service network in the United States, commonly referred to as a 9-1-1 network. The teachings of the present invention are equally applicable, useful and novel in other special number calling systems, such as maintenance service networks, college campus security networks and other networks.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

When the terms “coupled” and “connected”, along with their derivatives, are used herein, it should be understood that these terms are not intended as synonyms for each other. Rather, in particular embodiments, “connected” is used to indicate that two or more elements are in direct physical or electrical contact with each other. “Coupled” is used to indicated that two or more elements are in either direct or indirect (with other intervening elements between them) physical or electrical contact with each other, or that the two or more elements co-operate or interact with each other (e.g., as in a cause-and-effect relationship).

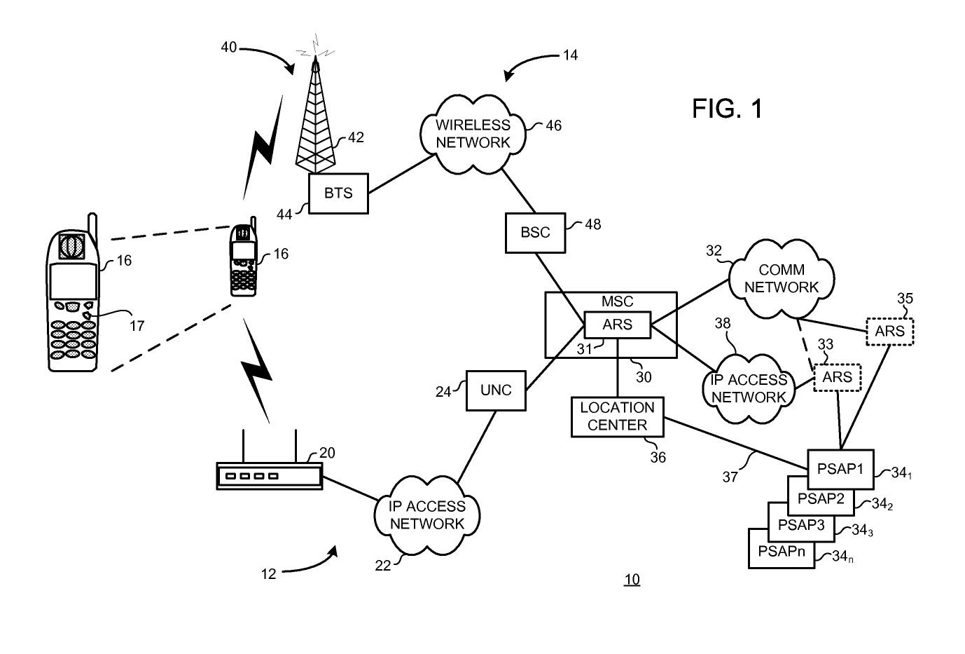

FIG. 1 is a schematic diagram illustrating a system for effecting emergency service calls with a wireless network. In FIG. 1, a telecommunication system 10 includes an Unlicensed Mobile Access (UMA) Network (UMAN) 12 and a Radio Access Network (RAN) 14. UMAN 12 may be embodied in, by way of example and not by way of limitation, a Wi-Fi network, a Bluetooth network or another type of UMA. RAN 14 may be embodied in, by way of example and not by way of limitation, a cellular network or a Personal Communication System (PCS) network employing any of several communication protocols including, by way of further example and not by way of limitation, GSM or another protocol using Time Division Multiple Access (TDMA), Code Division Multiple Access (CDMA) or another coding scheme. UMAN 12 and RAN 14 are configured for wireless communication with a wireless calling unit or instrument 16. Wireless calling unit 16 may be embodied in a wireless calling device including, by way of example and not by way of limitation, mobile telephone, Personal Digital Assistant (PDA) devices, “Smart” phones, automatic crash notification (ACN) units, mobile radio devices and similar communication devices. Wireless calling unit 16 is illustrated in FIG. 1 in an enlarged representation to effect identification of a single-button alerting actuator 17 integrally coupled within wireless calling unit 16.

UMAN 12 includes an access unit 20 coupled with an Internet Protocol (IP) access network 22. Access unit 20 facilitates communication between wireless communicating unit 16 and IP network 22. IP network 22 is coupled with a UMA Network Controller (UNC) 24. UNC 24 is coupled with a Mobile Switching Center (MSC) 30. MSC 30 is coupled with a communication network 32. MSC 30 is also coupled with a location center 36.

Communication network 32 is coupled with a selected Public Safety Answering Point (PSAP; sometimes referred to as a Public Safety Answering Position) 34₁, 34₂, 34₃, 34ₙ. The indicator “n” is employed to signify that there can be any number of PSAPs in telecommunication system 10. The inclusion of four PSAPs 34₁, 34₂, 34₃, 34ₙ in FIG. 1 is illustrative only and does not constitute any limitation regarding the number of PSAPs that may be included in the telecommunication system of the present invention. Throughout this description, use of a reference numeral using a generic subscript herein may be taken to mean that any respective member of the plurality of elements having the same reference numeral may be regarded as included in the description. Thus, by way of example and not by way of limitation, referring to PSAP 34ₙ in describing FIG. 1 may be taken to mean that any PSAP—34₁, 34₂, 34₃ or 34ₙ (FIG. 1)—may be regarded as capable of employment as described.

MSC 30 cooperates with location center 36 to ascertain the locus of calling instrument 16 for the extant call. Location information may be employed by MSC 30 to determine which PSAP 34ₙ should receive an emergency call placed by calling instrument 16 based upon the location of calling instrument 16. MSC 30 may include an Accident Report Server (ARS) 31. ARS 31 may be housed in MSC 30, may be integrally connected within MSC 30, may be embodied in a portion of software operated by MSC 30 or may otherwise be located with or incorporated in MSC 30.

Alternatively, telecommunication system 10 may include an ARS 33 coupled between IP access network 38 and PSAPs 34ₙ. ARS 33 may be coupled with communication network 32. In another alternate embodiment telecommunication system 10 may include an ARS 35 coupled between communication network 32 and PSAPs 34ₙ. Not shown in FIG. 1 to avoid cluttering the drawing is that IP access network 38 may be coupled with ARS 35 in a manner understood by those skilled in the art of telecommunication system design. Combinations of ARS 31, ARS 33 and ARS 35 may be employed to effect a partitioned or otherwise shared performance of functions by ARS 31, ARS 33 and ARS 35.

PSAP 34ₙ may be connected with MSC 30 via an IP network 38 to permit communication between PSAP 34ₙ and MSC 30 without involving communication network 32. PSAP 34ₙ may be directly coupled with location center 36 via a direct connection 37 to permit communication between PSAP 34ₙ and location center 36 without traversing an intervening network.

RAN 14 includes an access unit 40 that includes a radio antenna embodied in a radio tower 42 and a Base Transceiver Station (BTS) 44 coupled with radio tower 42. BTS 44 is coupled with a private network 46. Private network 46 may be embodied in, by way of example and not by way of limitation, a cellular network or a PCS network employing any of several communication protocols including, by way of further example and not by way of limitation, GSM or another protocol using Time Division Multiple Access (TDMA), Code Division Multiple Access (CDMA) or another coding scheme. Access unit 40 facilitates communication between wireless communicating unit 16 and private network 46. Private network 46 is coupled with a Base Station Controller (BSC) 48. BSC 48 is coupled with MSC 30.

Calling unit 16 may wirelessly access UMAN 12 to place an emergency 9-1-1 call via access unit 20 to establish communication with PSAP 34ₙ via IP network 22, UNC 24, MSC 30 and one or both of communication network 32 and IP network 38.

Calling unit 16 may instead wirelessly access RAN 14 to place an emergency 9-1-1 call via BTS 44 to establish communication with PSAP 34ₙ via BSC and MSC 130.

When communication is established between calling unit 16 and PSAP 34ₙ, PSAP 34ₙ may inquire of calling unit 16 or inquire of a user of calling unit 16 regarding the circumstance or circumstances that are the occasion for the call. PSAP 34ₙ, or an operator or evaluator manning PSAP 34ₙ can evaluate or triage the situation described by calling instrument 16 (e.g., in the case of an ACN unit) or a user of calling unit 16 and may be able to identify the nature of the circumstances.

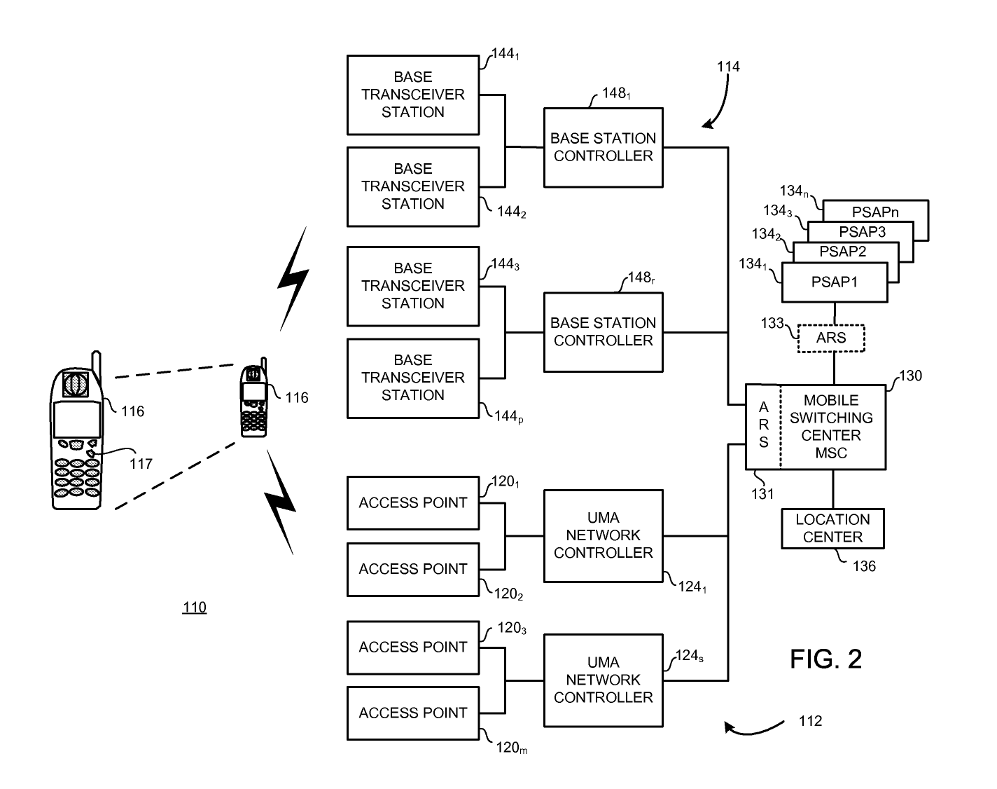

FIG. 2 is a schematic diagram illustrating call routing for a system configured according to the teaching of the present invention deployed in a representative multi-network arrangement. In FIG. 2, a telecommunication system 110 includes an Unlicensed Mobile Access (UMA) Network (UMAN) 112 and a Radio Access Network (RAN) 114. UMAN 112 may include, by way of example and not by way of limitation, a Wi-Fi network, a Bluetooth network or another type of UMA. RAN 114 may include, by way of example and not by way of limitation, a cellular network or a Personal Communication System (PCS) network employing any of several communication protocols including, by way of further example and not by way of limitation, GSM or another protocol using Time Division Multiple Access (TDMA), Code Division Multiple Access (CDMA) or another coding scheme. UMAN 112 and RAN 114 are configured for wireless communication with a wireless calling unit or instrument 116. Wireless calling unit 116 is illustrated in FIG. 2 in an enlarged representation to effect identification of a single-button alerting actuator 117 integrally coupled with wireless calling unit 116.

UMAN 112 includes access units 120₁, 120₂, 120₃, 120ₘ coupled for call routing via an Internet Protocol (IP) network (not shown in FIG. 2; see IP network 22, FIG. 1). The indicator “m” is employed to signify that there can be any number of access units in telecommunication system 110. The inclusion of four access units 120₁, 120₂, 120₃, 120ₘ in FIG. 2 is illustrative only and does not constitute any limitation regarding the number of access units that may be included in a telecommunication system employing the present invention.

Access units 120₁, 120₂, 120₃, 120ₘ facilitate communication with a wireless communicating unit 116. Calls from access units 120₁, 120₂ may be placed with a UMA Network Controller (UNC) 124₁. Calls from access units 120₃, 120ₘ may be placed with a UMA Network Controller (UNC) 124ₛ. The indicator “s” is employed to signify that there can be any number of UNCs in telecommunication system 110. The inclusion of two UNCs 124₁, 124ₛ in FIG. 2 is illustrative only and does not constitute any limitation regarding the number of UNCs that may be included in a telecommunication system employing the present invention. UNCs 124₁, 124ₛ are coupled with a Mobile Switching Center (MSC) 130. MSC 130 is coupled for call routing with a receiving or called party such as, by way of example and not by way of limitation, PSAP 134 via a communication network (not shown in FIG. 2; see communication network 30, FIG. 1). MSC 130 is also coupled with a location center 136.

MSC 130 may include an Accident Report Server (ARS) 131. ARS 131 may be housed in MSC 130, may be integrally connected within MSC 130, may be embodied in a portion of software operated by MSC 130 or may otherwise be located with or incorporated in MSC 130.

Alternatively, telecommunication system 10 may include an ARS 133 coupled between MSC 130 and PSAPs 134ₙ. A combination of ARS 131 and ARS 133 may be employed to effect a partitioned or otherwise shared performance of functions by ARS 131 and ARS 133.

RAN 114 includes access units represented in FIG. 2 by Base Transceiver Stations (BTS) 144₁, 144₂, 144₃, 144ₚ. The indicator “p” is employed to signify that there can be any number of BTSs in telecommunication system 110. The inclusion of four BTSs 144₁, 144₂, 144₃, 144ₚ in FIG. 2 is illustrative only and does not constitute any limitation regarding the number of BTSs that may be included in a telecommunication system employing the present invention.

BTSs 144₁, 144₂, 144₃, 144ₚ are coupled for call routing with MCS 130 via a private network (not shown in FIG. 2; see private network 46, FIG. 1). BTSs 144₁, 144₂, 144₃, 144ₚ facilitate communication with wireless communicating unit 116. BTSs 144₁, 144₂, 144₃, 144ₚ are coupled with a Base Station Controllers (BSC) 148₁, 148ᵣ. Calls from BTSs 144₁, 144₂ may be placed with BSC 148₁. Calls from BTSs 144₃, 144ₚ may be placed with a BSC 148ᵣ. The indicator “r” is employed to signify that there can be any number of BSCs in telecommunication system 110. The inclusion of two BSCs 148₁, 148ᵣ in FIG. 2 is illustrative only and does not constitute any limitation regarding the number of BSCs that may be included in a telecommunication system employing the present invention. BSCs 148₁, 148ᵣ are coupled with MSC 130. MSC 130 is coupled with a selected Public Safety Answering Point (PSAP; sometimes referred to as a Public Safety Answering Position) 134₁, 134₂, 134₃, 134ₙ. The indicator “n” is employed to signify that there can be any number of PSAPs in telecommunication system 110. The inclusion of four PSAPs 134₁, 134₂, 134₃, 134ₙ in FIG. 2 is illustrative only and does not constitute any limitation regarding the number of PSAPs that may be included in the telecommunication system of the present invention.

Calling unit 116 may wirelessly access UMAN 112 to place an emergency 9-1-1 call via an access unit 120₁, 120₂, 120₃, 120ₘ to establish communication with a selected PSAP 134ₙ via a UNC 124₁, 124ₛ and MSC 130.

Calling unit 116 may instead wirelessly access RAN 114 to place an emergency 9-1-1 call via a BTS 144₁, 144₂, 144₃, 144ₚ to establish communication with selected PSAP 134ₙ via a BSC 148₁, 148ᵣ and MSC 130.

When communication is established between calling unit 116 and PSAP 134ₙ, PSAP 134ₙ may inquire of calling unit 116 or inquire of a user of calling unit 116 regarding the circumstance or circumstances that are the occasion for the call. PSAP 134ₙ, or an operator or evaluator manning PSAP 134ₙ can evaluate or triage the situation described by calling instrument 116 (e.g., in the case of an ACN unit) or a user of calling unit 116 and may be able to identify the nature of the circumstances.

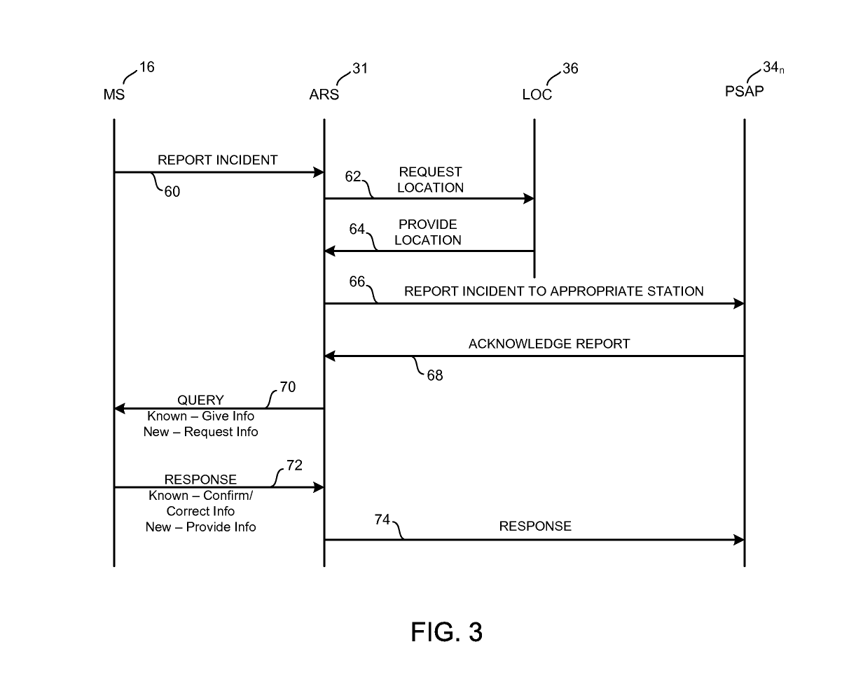

FIG. 3 is a call flow diagram illustrating details relating to effecting an emergency service call employing the teachings of the present invention. In FIG. 3, an emergency service call may be initiated by a user employing a mobile calling unit 16 (see FIG. 1) to report an incident to an ARS 31, as indicated at 60. The reporting may be effected using a single-button alerting actuator 17 (FIG. 1). Reporting of an incident using single-button alerting actuator 17 may include predetermined information such as, by way of example and not by way of limitation, location of calling unit 16 and telephone number (TN) or other identification of calling instrument 16. If the single-button alerting actuator 17 does not include location information with the incident report, ARS 31 may present a location request to a location center 36, as indicated at 62. Location center 36 may provide location information to ARS 31, as indicated at 64.

ARS 31 may employ the location information provided by location center 36 to determine which PSAP 34ₙ should receive the incident report based upon the location of mobile calling unit 16. MSC 30 may present an incident report, including location information, to a selected PSAP 34ₙ, as indicated at 66.

PSAP 34ₙ acknowledges the incident report to ARS 31, as indicated at 68. As indicated at 70, if PSAP 34ₙ believes that the extant emergency reported as indicated at 66 is related to an earlier-reported emergency, PSAP 34ₙ may give information relating to the earlier-reported emergency to mobile calling unit 16, and may inquire whether mobile calling unit 16 can provide additional information relating to the earlier-reported emergency. If PSAP 34ₙ does not believe that the extant emergency reported is related to an earlier-reported emergency, PSAP 34ₙ may request mobile calling unit 16 to provide information relating to the extant emergency.

As indicated at 72, mobile calling unit 16 may respond to provide confirming or other information relating to an earlier-reported emergency or may provide new information relating to the extant emergency to ARS 31, as appropriate. ARS 31 may provide the response from mobile calling unit 16 to PSAP 34ₙ, as indicated at 74.

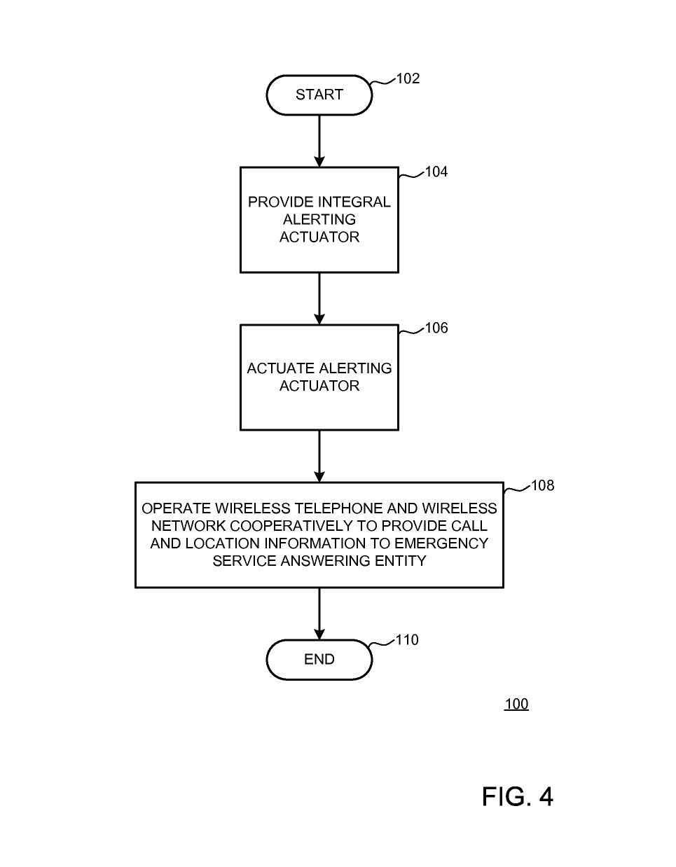

FIG. 4 is a flow diagram illustrating the method of the present invention. In FIG. 4, a method 100 for operating a wireless telephone with a wireless network begins at a START locus 102. Method 100 continues with providing an alerting actuator integrally coupled with the wireless telephone, as indicated by a block 104.

Method 100 continues with actuating the alerting actuator to effect initiation of an emergency service call by the wireless telephone via the wireless network, as indicated by a block 106.

Method 100 continues with operating the wireless telephone and the wireless network cooperatively to provide the emergency service call and location information regarding locus of the apparatus to an emergency service answering entity, as indicated by a block 108. Method 100 terminates at an END locus 110.

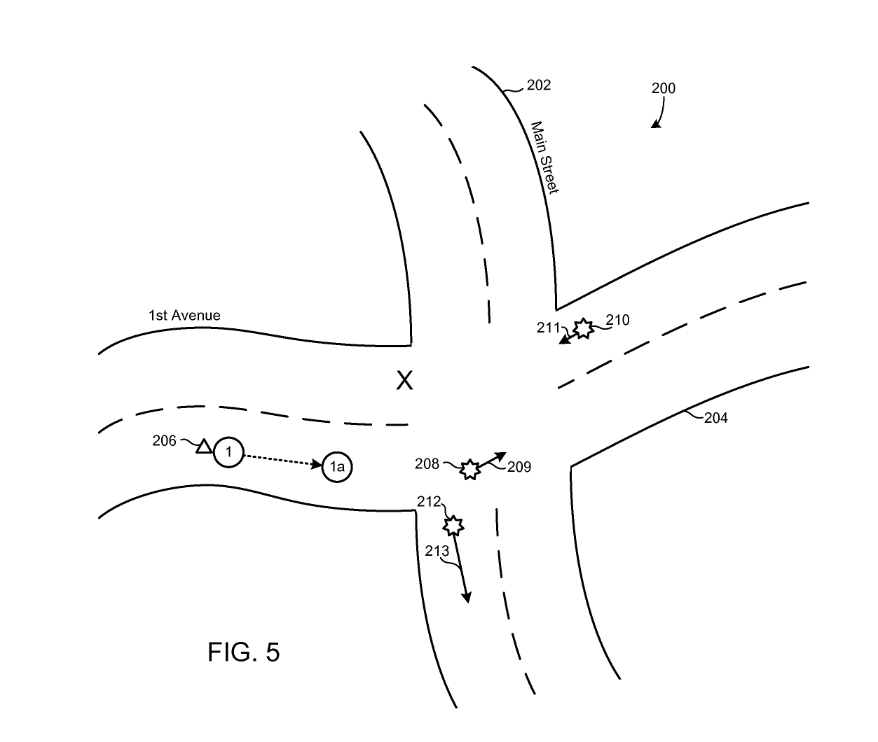

FIG. 5 is a schematic diagram of a display at an answering position indicating information provided by the present invention. In FIG. 5, a representation of an intersection 200 of Main Street 202 with 1^{st} Avenue 204 is presented indicating the locus or site of an accident, incident or other noteworthy event at a position “X”. A first traveler 206 situated at a first locus “1” may call in a report of the incident at locus X using a single-button alerting actuator 17 integrally coupled within wireless calling unit 16 (FIG. 1). During reporting and thereafter, first traveler 206 may proceed along 1^{st} Avenue 202 for example to a position “1a”. Repeat reports by first traveler 206 using his wireless calling unit maybe used by telecommunication system 10 to ascertain direction of travel and speed by first traveler so that first traveler 206 may be indicated on the display of intersection 200 as an icon 208 with an accompanying vector 209. Icon 208 indicates the position of first traveler 206. Vector 209 indicates the direction of travel and speed of first traveler 206.

Accident reports by a second traveler may result in the display of intersection 200 indicating the location of the second traveler by an icon 210 with an accompanying vector 211 indicating the direction of travel and speed of the second traveler. Vector 211 is shorter than vector 209 indicating that the second traveler is proceeding at a slower speed than first traveler 206.

Accident reports by a third traveler may result in the display of intersection 200 indicating the location of the third traveler by an icon 212 with an accompanying vector 213 indicating the direction of travel and speed of the third traveler. Vector 213 is longer than vector 211 indicating that the third traveler is proceeding at a faster speed than the second traveler.

Information presented in a display such as the display of intersection 200 of FIG. 5 permits a PSAP or other answering position to identify travelers near an incident site X. The answering position may call the other identified travelers (e.g., if the accident reporting includes a contact number) to inquire regarding conditions at or near site X.

It is to be understood that, while the detailed drawings and specific examples given describe embodiments of the invention, they are for the purpose of illustration only, that the system and method of the invention are not limited to the precise details and conditions disclosed and that various changes may be made therein without departing from the spirit of the invention which is defined by the following claims:

1. A wireless telephone apparatus configured for operation with a wireless network; the apparatus comprising: an alerting actuator integrally coupled with the apparatus; actuating said alerting actuator effecting initiation of an emergency service call by the apparatus via said wireless network; and the apparatus and said wireless network cooperating to provide said emergency service call and location information regarding locus of the apparatus to an emergency service answering entity.

2. The wireless telephone apparatus configured for operation with a wireless network as recited in claim 1 wherein said emergency service answering entity employs said location information to determine whether an extant emergency reported by said emergency service call may be related to an earlier-reported emergency.

3. The wireless telephone apparatus configured for operation with a wireless network as recited in claim 2 wherein, if said emergency service answering entity determines that said extant emergency reported by said emergency service call may be related to an earlier-reported emergency, said emergency service answering entity effects a return call to the apparatus; said return call indicating to a user of the apparatus that said extant emergency reported by said emergency service call may be related to an earlier-reported emergency and providing selected information about said earlier-reported emergency.

4. The wireless telephone apparatus configured for operation with a wireless network as recited in claim 3 wherein said return call requests said user of the apparatus to use said selected information to confirm whether said extant emergency reported by said emergency service call may be related to said earlier-reported emergency.

5. The wireless telephone apparatus configured for operation with a wireless network as recited in claim 2 wherein, if said emergency service answering entity determines that said extant emergency service call may not be related to an earlier-reported emergency, said emergency service answering entity effects a return call to a user of the apparatus requesting additional information relating to said extant emergency.

6. The wireless telephone apparatus configured for operation with a wireless network as recited in claim 2 wherein said emergency service answering entity is a Public Safety Answering Position.

7. The wireless telephone apparatus configured for operation with a wireless network as recited in claim 2 wherein said alerting actuator is a single button.

8. An alerting apparatus for use with a wireless telephone configured for operation with a wireless network; the apparatus comprising: an alerting actuator integrally coupled with said wireless telephone; actuating the apparatus effecting initiation of an emergency service call by said wireless telephone via said wireless network; said wireless telephone and said wireless network cooperating to provide said emergency service call and location information regarding locus of said wireless telephone to an emergency service answering entity.

9. An alerting apparatus for use with a wireless telephone configured for operation with a wireless network as recited in claim 8 wherein said emergency service answering entity employs said location information to determine whether an extant emergency reported by said emergency service call may be related to an earlier-reported emergency.

10. An alerting apparatus for use with a wireless telephone configured for operation with a wireless network as recited in claim 9 wherein, if said emergency service answering entity determines that said extant emergency reported by said emergency service call may be related to an earlier-reported emergency, said emergency service answering entity effects a return call to said wireless telephone; said return call indicating to a user of said wireless telephone that said extant emergency reported by said emergency service call may be related to an earlier-reported emergency and providing selected information about said earlier-reported emergency.

11. An alerting apparatus for use with a wireless telephone configured for operation with a wireless network as recited in claim 10 wherein said return call requests said user of said wireless telephone to use said selected information to confirm whether said extant emergency reported by said emergency service call may be related to said earlier-reported emergency.

12. An alerting apparatus for use with a wireless telephone configured for operation with a wireless network as recited in claim 9 wherein, if said emergency service answering entity determines that said extant emergency service call may not be related to an earlier-reported emergency, said emergency service answering entity effects a return call to a user of said wireless telephone requesting additional information relating to said extant emergency.

13. An alerting apparatus for use with a wireless telephone configured for operation with a wireless network as recited in claim 9 wherein said emergency service answering entity is a Public Safety Answering Position.

14. An alerting apparatus for use with a wireless telephone configured for operation with a wireless network as recited in claim 9 wherein said alerting actuator is a single button.

15. A method for operating a wireless telephone with a wireless network; the method comprising:
(a) providing an alerting actuator integrally coupled with said wireless telephone;
(b) actuating said alerting actuator to effect initiation of an emergency service call by said wireless telephone via said wireless network; and
(c) operating said wireless telephone and said wireless network cooperatively to provide said emergency service call and location information regarding locus of the apparatus to an emergency service answering entity.

16. A method for operating a wireless telephone apparatus with a wireless network as recited in claim 15 wherein said emergency service answering entity employs said location information to determine whether an extant emergency reported by said emergency service call may be related to an earlier-reported emergency.

17. A method for operating a wireless telephone apparatus with a wireless network as recited in claim 16 wherein, if said emergency service answering entity determines that said extant emergency reported by said emergency service call may be related to an earlier-reported emergency, said emergency service answering entity effects a return call to said wireless telephone; said return call indicating to a user of said wireless telephone that said extant emergency reported by said emergency service call may be related to an earlier-reported emergency and providing selected information about said earlier-reported emergency.

18. A method for operating a wireless telephone apparatus with a wireless network as recited in claim 17 wherein said return call requests said user of said wireless telephone to use said selected information to confirm whether said extant emergency reported by said emergency service call may be related to said earlier-reported emergency.

19. A method for operating a wireless telephone apparatus with a wireless network as recited in claim 16 wherein, if said emergency service answering entity determines that said extant emergency service call may not be related to an earlier-reported emergency, said emergency service answering entity effects a return call to a user of said wireless telephone requesting additional information relating to said extant emergency.

20. A method for operating a wireless telephone apparatus with a wireless network as recited in claim 16 wherein said alerting actuator is a single button.
